(19) United States
(12) Patent Application Publication
(10) Pub. No.: US 2008/0118317 A1
(43) Pub. Date: May 22, 2008

(54) Drill with a hard material drilling head

(76) Inventor: Thorsten Assel, Landsberg (DE)

Correspondence Address: ABELMAN, FRAYNE & SCHWAB, 666 THIRD AVENUE, 10TH FLOOR, NEW YORK, NY, 10017, US

(21) Appl. No.: 11/985,832

(22) Filed: Nov. 16, 2007

(30) Foreign Application Priority Data
Nov. 17, 2006 (DE) 10 2006 035 453.2

(51) Int. Cl. B23B 41/00; B23B 51/00; B23B 39/00

(52) U.S. Cl. 408/206; 408/227; 408/125

(57) ABSTRACT

A one-piece drilling head (4), which is securable, in a material-locking manner, on an axial end of a helical shaft of a drill, is formed of a hard material and has four radially extending, in a cross-shaped manner, legs (5) forming respective cutting edges (6), and a tangential reinforcement (7) provided at a radially outer rim of each leg (5) in an axial region of a cutting edge (6).

### BACKGROUND OF THE INVENTION

1. Field of the Invention

The present invention relates to a boring tool with a hard material drilling head and, in particular, to a rotary-percussion drill for stone and reinforced concrete and to be used with a high-power hand-held power tool. More specifically, the present invention relates to the hard material drilling head for the rotary-percussion drill.

2. Description of the Prior Art

Usually, a drill which is mentioned above, has a helical shaft extending axially along a rotational axis of the drill and provided on its power tool-side end with a shank for insertion in a chuck of the power tool and at its opposite workpiece-side end with a hard material head butt-brazed to the end surface of the shaft.

German Publication DE 29 12 394 discloses a drill for stone with a one-piece, cross-shaped, hard material drilling head with four radial legs and a centering tip. Each radially extending leg uniformly (with regard to the radial cross-section) continuously extends to the radially outer rim.

According to German Publication DE 100 09 732, in the drilling head, both radially shorter auxiliary cutting edges are axially offset backward with respect to both diametrically opposite main cutting edges.

German Publication DE 100 06 932 discloses a one-piece, X-shaped drilling head both auxiliary cutting edges of which form, in radially outer edge region, ramp means inclined in the rotational direction and which increases robustness against encounter with the reinforcing iron and which uniformly (with respect to the radial cross-section) continuously extends up to the radially outer rim.

An object of the invention is to further increase the robustness of a drilling head of the above-descried type against a sidewise encounter with the reinforcing iron.

Another object of the present invention is to insure a uniform drilling capacity over the useful life of the drilling head.

### SUMMARY OF THE INVENTION

These and other objects of the present invention, which will become apparent hereinafter, are achieved by providing a one-piece, hard material drilling head securable on an axial end of a helical shaft of a rotary-percussion drill in a material-locking manner and having four radially extending, in a cross-shaped manner, legs forming, respectively, four cutting edges, and a tangential reinforcement provided at a radially outer rim of each leg in an axial region of a cutting edge.

The tangential reinforcement of the cutting edges, which are loaded particularly high at a sidewise encounter with the reinforcing iron, increases the tangential flexural strength of the cutting edges and, thus, increases robustness of the drilling head against a sidewise encounter with the reinforcing iron.

Advantageously, the reinforcement forms a surface (flat or curved) inclined in a rotational direction. This surface serves as a ramp surface upon encounter with the reinforcing iron, and axially lifts the rotating drill at its side adjacent to the drive.

Advantageously, the reinforcement is tangentially two-sided, which provides additional support for the cutting edge in the direction opposite the rotational direction. This increases the fracture resistance of the cutting edge corner.

Advantageously, a cutting edge extends radially into the reinforcement, whereby a reinforcement rim is formed on the outer radial rim of the cutting edge. This increases the fracture resistance and reduces wear upon application of a rotary load.

Advantageously, all four cutting edges form, with respect to rotation about a rotational axis, different axial envelope surfaces, respectively, at least in a radially outer third of the drilling head. Thereby, the cutting edges wear off, with time, one after another over the service life of the drilling head and remain abrasively effective, which provides for a uniform drilling capacity over the service life of the drilling head.

Advantageously, a maximal axial variation of the axial envelope surfaces amounts to from one/tenth to one/fourth of an envelope diameter. This permits to achieve practically a satisfactory service life and uniform drilling capacity. This variation can also be non-uniformly distributed over separate cutting edges.

Advantageously, a centering tip and two, radially extending, centering cutting edges, the centering axial envelope surfaces of which project, axially, at the workpiece side of the drilling head, beyond the axial envelope surfaces of the cutting edges, are provided in a radially inner third of the drilling head. Thereby, good centering is achieved even in rough constructional material such as concrete.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1a a front view of a drilling head of a drill according to the present invention;

FIG. 1b a side view of the drilling head shown in FIG. 1;

FIG. 1c a plan view of the drilling head shown in FIGS. 1-2;

FIG. 2 a radial cross-secfional view along line II-II in FIG. 1c; and

FIG. 3 a side view of a section III in FIG. 1a.

### DETAILED DESCRIPTION OF THE PREFERRED EMBODIMENT

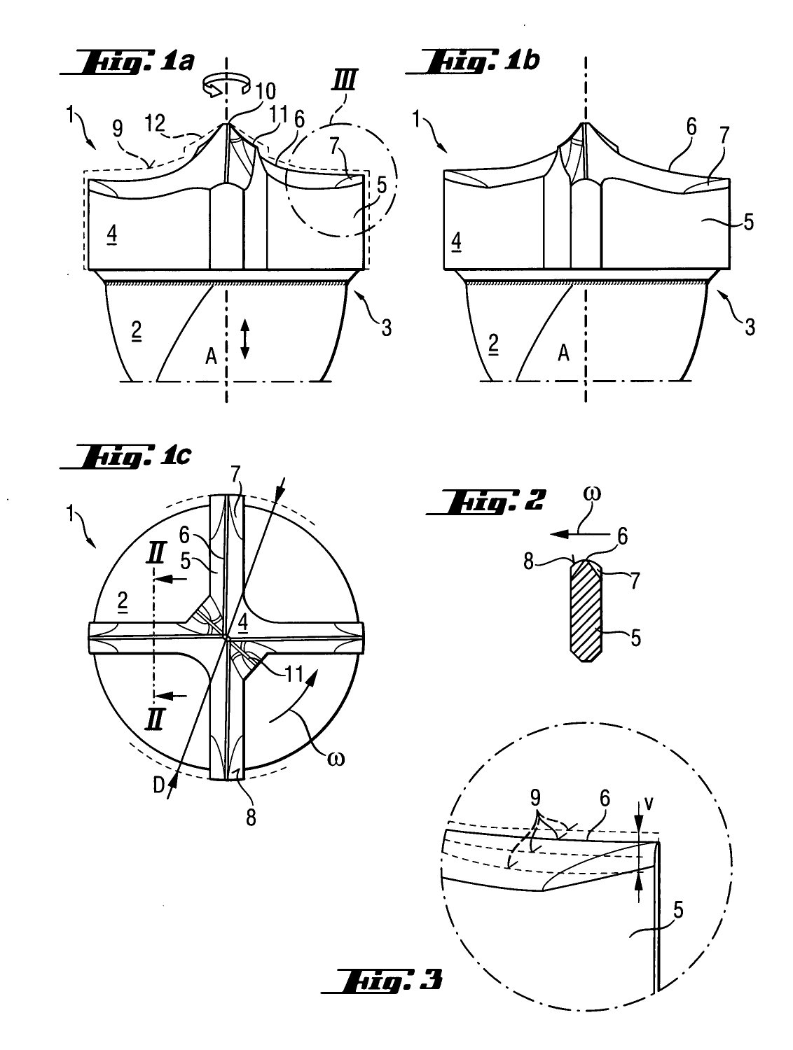

A one-piece drilling head 4 according to the present invention, which is shown in FIGS. 1a, 1b, and 1c, is formed of a hard material and is secured in a material locking manner at an end 3 of a helically shaped shaft 2 of a drill 1 rotatable about a rotational axis A and percussively displaceable therealong. The hard material drilling head 4 has four, radially extending, in a cross-shaped manner, legs 5 with cutting edges 6. Each cutting edge 6 ends radially in a reinforcement 7. In the radially inner third of the drilling head 4, there is provided a centering tip 10 and two, radially extending, centering cutting edges 11 the centering axial envelope surfaces 12 of which project, with respect to the rotation about a rotational axis A, axially, at the workpiece side of the drilling head 4, beyond the axial envelope surfaces 9 of the cutting edges 6.

According to FIG. 2, the leg 5 has, at its radially outer edge, in the axial region of the cutting edge 6, a two-sided tangentional reinforcement 7 that forms, on the rotational direction-side, also a surface 8 inclined in the rotational direction (ω).

According to FIG. 3, all four cutting edges 6 form respective different axial envelope surfaces 9, with a maximal axial variation V of the axial envelope surfaces 9 amounting to one/tenth of the envelope diameter D (FIG. 1c).

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A one-piece drilling head (4) for a drill and formed of hard material, comprising four radially extending, in a cross-shaped manner, legs (5) forming, respective cutting edges (6); and a tangential reinforcement (7) provided at a radially outer rim of each leg (5) in an axial region of a cutting edge (6).

2. A drilling head according to claim 1, wherein the reinforcement (7) forms a surface (8) inclined in a rotational direction (ω).

3. A drilling head according to claim 1, wherein the reinforcement (7) is tangentially two-sided.

4. A drilling head according to claim 1, wherein a cutting edge (6) extends radially into the reinforcement (7).

5. A drilling head according to claim 1, wherein all four cutting edges (6) form, with respect to rotation about a rotational axis (A), different axial envelope surfaces (9), respectively, at least in a radially outer third of the drilling head.

6. A drilling head according to claim 5, wherein a maximal axial variation (V) of the axial envelope surfaces (9) amounts to from one/tenth to one/fourth of an envelope diameter (D).

7. A drilling head according to claim 1, comprising a centering tip (10) and two, radially extending, centering cutting edges (11) the centering axial envelope surfaces (12) of which project, axially, at the workpiece side of the drilling head (4), beyond the axial envelope surfaces (9) of the cutting edges (6), the centering tip (10) and the centering cutting edges (11) being provided in a radially inner third of the drilling head (4).

8. A drill, comprising a helically shaped shaft (2); and a one-piece drilling head (4) formed of a hard material and secured on an axial end (3) of the shaft (2) in a material-locking manner, the drilling head including four radially extending, in a cross-shaped manner, legs (5) forming, respectively, four cutting edges (6), and a tangential reinforcement (7) provided at a radially outer rim of each leg (5) in an axial region of a cutting edge (6).
